(19) United States
(12) Patent Application Publication
(10) Pub. No.: US 2026/0107157 A1
(43) Pub. Date: Apr. 16, 2026

(54) TRAINING DATA COLLECTION

(71) Applicant: Nokia Technologies Oy, Espoo (FI)

(72) Inventors: Oana-Elena BARBU, Aalborg (DK); István Zsolt KOVÁCS, Aalborg (DK)

(21) Appl. No.: 19/115,038

(22) PCT Filed: Aug. 16, 2023
(86) PCT No.: PCT/EP2023/072554

§ 371 Date: Mar. 25, 2025

(30) Foreign Application Priority Data
Sep. 28, 2022 (GB) 2214157.6

(51) Int. Cl. H04W 24/02

(52) U.S. Cl. CPC H04W 24/02

(57) ABSTRACT

An apparatus, comprising: a co-ordinator function configured to send a first configuration message to a first collector function, the first configuration message including information to configure the first collector function to collect first training data, to transform the first training data to generate transformed first training data and to report the transformed first training data.

### TECHNOLOGICAL FIELD

Various example embodiments relate to collecting training data.

### BACKGROUND

In wireless telecommunications networks, network nodes collect and process training data to train Machine Learning (ML) models to improve the operation of the network. Although techniques exist for collecting and processing training data, unexpected consequences can occur. Accordingly, it is desired to provide an improved technique for collecting and processing training data.

### BRIEF SUMMARY

The scope of protection sought for various example embodiments of the invention is set out by the independent claims. The example embodiments and features, if any, described in this specification that do not fall under the scope of the independent claims are to be interpreted as examples useful for understanding various embodiments of the invention.

According to various, but not necessarily all, example embodiments of the invention there is provided an apparatus, comprising: a co-ordinator function configured to send a first configuration message to a first collector function, the first configuration message including information to configure the first collector function to collect first training data, to transform the first training data to generate transformed first training data and to report the transformed first training data.

The first training data may comprise an N-dimension matrix of values collected by the first collector function.

The values may comprise channel information. The channel information may relate to a wireless link between an entity hosting the collector function and a transmitter. The channel information may comprise beamforming and/or channel values.

The first configuration message may include information to configure the first collector function to transform the first training data to generate the transformed first training data by removing specified vendor-specific data and/or artifacts. The specified vendor-specific data and/or artifacts may comprise radio frequency receiver delays, number of radio frequency chains, and the like.

The first configuration message may include information to configure the first collector function to transform the first training data to generate the transformed first training data with a target reconfiguration.

The first configuration message may include information to configure the first collector function to report the transformed first training data in a transformed training data format and/or with a specified reporting periodicity.

The transformed first training data may comprise an N-dimension matrix of values collected by the first collector function.

The first configuration message may include information to configure the first collector function to report the transformed first training data to the co-ordinator function and/or to a training function.

The first configuration message may include information to configure the first collector function to report the transformed first training data to both a first training function and a second training function.

The co-ordinator function may be configured to send a second configuration message to a second collector function, the second configuration message including information to configure the second collector function to collect second training data, to reconfigure the second training data to generate transformed second training data and to report the transformed second training data.

The co-ordinator function may be configured to combine received transformed training data to form combined transformed training data. The received transformed training data may be from multiple collector functions and/or from the same collector function at different times.

The co-ordinator function may be configured to combine received transformed training data by superimposing, averaging, filtering, pruning, puncturing, scaling and/or normalising.

The co-ordinator function may be configured to send the combined transformed training data to the training function.

The co-ordinator function may be configured to send a configuration message to a collector function provided by a vendor common to the co-ordinator function and the collector function, the configuration message including instructions to configure the collector function to collect training data and to report the training data.

The co-ordinator function may be configured to send a conversion configuration message to the training function, the conversion configuration message including information to configure the training function to convert received transformed training data to and/or received combined transformed training data to converted training data.

The conversion configuration message may include information to configure the training function to convert received transformed training data to and/or received combined transformed training data to converted training data by augmentation, superimposing, averaging, filtering, pruning, puncturing, normalising, scaling and/or translation. The conversion may be by a suitable filtering or projection operation.

The co-ordinator function may be configured to send a first conversion configuration message to the first training function, the first conversion configuration message including information to configure the first training function to convert received transformed training data to and/or received combined transformed training data to first converted training data and a second conversion configuration message to a second training function, the second conversion configuration message including information to configure the second training function to convert received transformed training data to and/or received combined transformed training data to second converted training data.

The messages and/or data may be transmitted on a Physical Sidelink Shared Channel, a Physical Downlink Shared Channel, a Physical Uplink Shared Channel and/or any wireless medium channel. The messages and/or data may be transmitted on a Physical Sidelink Control Channel, Physical Downlink Common Control Channel and/or Physical Uplink Common Channel. The messages and/or data may be transmitted on other than an air-interface such as over F1, Xn and/or NG interfaces. The messages and/or data may be transmitted over O-RAN A1, E1, E2, F1 interfaces. It will be appreciated that these are applicable to 4G, 5G and 6G systems.

The training data, transformed training data and/or transformed training data may comprise a data format specified by a combination of parameters associated with the training data such as: sampling resolution; array shape: scalar, vector, matrix; and/or length, and the like.

According to various, but not necessarily all, example embodiments of the invention there is provided a method, comprising: sending a first configuration message to a first collector function, the first configuration message including information to configure the first collector function to collect first training data, to transform the first training data to generate transformed first training data and to report the transformed first training data.

The first training data may comprise an N-dimension matrix of values collected by the first collector function.

The values may comprise channel information. The channel information may relate to a wireless link between an entity hosting the collector function and a transmitter. The channel information may comprise beamforming and/or channel values.

The first configuration message may include information to configure the first collector function to transform the first training data to generate the transformed first training data by removing specified vendor-specific data and/or artifacts. The specified vendor-specific data and/or artifacts may comprise radio frequency receiver delays, number of radio frequency chains, and the like.

The first configuration message may include information to configure the first collector function to transform the first training data to generate the transformed first training data with a target reconfiguration.

The first configuration message may include information to configure the first collector function to report the transformed first training data in a transformed training data format and/or with a specified reporting periodicity.

The transformed first training data may comprise an N-dimension matrix of values collected by the first collector function.

The first configuration message may include information to configure the first collector function to report the transformed first training data to the co-ordinator function and/or to a training function.

The first configuration message may include information to configure the first collector function to report the transformed first training data to both a first training function and a second training function.

The method may comprise sending a second configuration message to a second collector function, the second configuration message including information to configure the second collector function to collect second training data, to reconfigure the second training data to generate transformed second training data and to report the transformed second training data.

The method may comprise combining received transformed training data to form combined transformed training data. The received transformed training data may be from multiple collector functions and/or from the same collector function at different times.

The method may comprise combining received transformed training data by superimposing, averaging, filtering, pruning, puncturing, scaling and/or normalising.

The method may comprise sending the combined transformed training data to the training function.

The sending may be performed by a co-ordinator function and the method may comprise sending a configuration message to a collector function provided by a vendor common to the co-ordinator function and the collector function, the configuration message including instructions to configure the collector function to collect training data and to report the training data.

The method may comprise sending a conversion configuration message to the training function, the conversion configuration message including information to configure the training function to convert received transformed training data to and/or received combined transformed training data to converted training data.

The conversion configuration message may include information to configure the training function to convert received transformed training data to and/or received combined transformed training data to converted training data by augmentation, superimposing, averaging, filtering, pruning, puncturing, normalising, scaling and/or translation. The conversion may be by a suitable filtering or projection operation.

The method may comprise sending a first conversion configuration message to the first training function, the first conversion configuration message including information to configure the first training function to convert received transformed training data to and/or received combined transformed training data to first converted training data and sending a second conversion configuration message to a second training function, the second conversion configuration message including information to configure the second training function to convert received transformed training data to and/or received combined transformed training data to second converted training data.

The messages and/or data may be transmitted on a Physical Sidelink Shared Channel, a Physical Downlink Shared Channel a Physical Uplink Shared Channel and/or any wireless medium channel. The messages and/or data may be transmitted on a Physical Sidelink Control Channel, Physical Downlink Common Control Channel and/or Physical Uplink Common Channel. The messages and/or data may be transmitted on other than an air-interface such as over F1, Xn and/or NG interfaces. The messages and/or data may be transmitted over O-RAN A1, E1, E2, F1 interfaces. It will be appreciated that these are applicable to 4G, 5G and 6G systems.

The training data, transformed training data and/or transformed training data may comprise a data format specified by a combination of parameters associated with the training data such as: sampling resolution; array shape: scalar, vector, matrix; and/or length, and the like.

According to various, but not necessarily all, example embodiments of the invention there is provided an apparatus, comprising: at least one processor; and at least one memory storing instructions that when executed by the at least one processor cause the apparatus at least to perform the method and its example embodiments set out above.

According to various, but not necessarily all, example embodiments of the invention there is provided a non-transitory computer readable medium comprising program instructions stored thereon for performing the method and its example embodiments set out above.

According to various, but not necessarily all, example embodiments of the invention there is provided an apparatus, comprising: a collector function configured to receive a configuration message from a co-ordinator function, the configuration message including information to configure the collector function to collect training data, to transform the training data to generate transformed training data and to report the transformed training data.

The training data may comprise an N-dimension matrix of values collected by the collector function.

The values may comprise channel information. The channel information may relate to a wireless link between an entity hosting the collector function and a transmitter. The channel information may comprise beamforming and/or channel values.

The configuration message may include information to configure the collector function to transform the training data to generate the transformed training data by removing specified vendor-specific data and/or artifacts. The specified vendor-specific data and/or artifacts may comprise radio frequency receiver delays, number of radio frequency chains, and the like.

The configuration message may include information to configure the collector function to transform the training data to generate the transformed training data with a target reconfiguration.

The configuration message may include information to configure the collector function to report the transformed training data in a transformed training data format and/or with a specified reporting periodicity.

The transformed training data may comprise an N-dimension matrix of values collected by the collector function.

The configuration message may include information to configure the collector function to report the transformed training data to the co-ordinator function and/or to a training function.

The configuration message may include information to configure the collector function to report the transformed training data to both a first training function and a second training function.

The collector function may be configured to receive a configuration message from a co-ordinator function provided by a vendor common to the collector function, the configuration message including instructions to configure the collector function to collect training data and to report the training data.

The messages and/or data may be transmitted on a Physical Sidelink Shared Channel, a Physical Downlink Shared Channel, a Physical Uplink Shared Channel and/or any wireless medium channel. The messages and/or data may be transmitted on a Physical Sidelink Control Channel, Physical Downlink Common Control Channel and/or Physical Uplink Common Channel. The messages and/or data may be transmitted on other than an air-interface such as over F1, Xn and/or NG interfaces. The messages and/or data may be transmitted over O-RAN A1, E1, E2, F1 interfaces. It will be appreciated that these are applicable to 4G, 5G and 6G systems.

The training data, transformed training data and/or transformed training data may comprise a data format specified by a combination of parameters associated with the training data such as: sampling resolution; array shape: scalar, vector, matrix; and/or length, and the like.

According to various, but not necessarily all, example embodiments of the invention there is provided a method, comprising: receiving a configuration message from a co-ordinator function, the configuration message including information to configure a collector function to collect training data, to transform the training data to generate transformed training data and to report the transformed training data.

The training data may comprise an N-dimension matrix of values collected by the collector function.

The values may comprise channel information. The channel information may relate to a wireless link between an entity hosting the collector function and a transmitter. The channel information may comprise beamforming and/or channel values.

The configuration message may include information to configure the collector function to transform the training data to generate the transformed training data by removing specified vendor-specific data and/or artifacts. The specified vendor-specific data and/or artifacts may comprise radio frequency receiver delays, number of radio frequency chains, and the like.

The configuration message may include information to configure the collector function to transform the training data to generate the transformed training data with a target reconfiguration.

The configuration message may include information to configure the collector function to report the transformed training data in a transformed training data format and/or with a specified reporting periodicity.

The transformed training data may comprise an N-dimension matrix of values collected by the collector function.

The configuration message may include information to configure the collector function to report the transformed training data to the co-ordinator function and/or to a training function.

The configuration message may include information to configure the collector function to report the transformed training data to both a first training function and a second training function.

The method may comprise receiving a configuration message from a co-ordinator function provided by a vendor common to the collector function, the configuration message including instructions to configure the collector function to collect training data and to report the training data.

The messages and/or data may be transmitted on a Physical Sidelink Shared Channel, a Physical Downlink Shared Channel, a Physical Uplink Shared Channel and/or any wireless medium channel. The messages and/or data may be transmitted on a Physical Sidelink Control Channel, Physical Downlink Common Control Channel and/or Physical Uplink Common Channel. The messages and/or data may be transmitted on other than an air-interface such as over F1, Xn and/or NG interfaces. The messages and/or data may be transmitted over O-RAN A1, E1, E2, F1 interfaces. It will be appreciated that these are applicable to 4G, 5G and 6G systems.

The training data, transformed training data and/or transformed training data may comprise a data format specified by a combination of parameters associated with the training data such as: sampling resolution; array shape: scalar, vector, matrix; and/or length, and the like.

According to various, but not necessarily all, example embodiments of the invention there is provided an apparatus, comprising: at least one processor; and at least one memory storing instructions that when executed by the at least one processor cause the apparatus at least to perform the method and its example embodiments set out above.

According to various, but not necessarily all, example embodiments of the invention there is provided a non-transitory computer readable medium comprising program instructions stored thereon for performing the method and its example embodiments set out above.

According to various, but not necessarily all, example embodiments of the invention there is provided an apparatus, comprising: a training function configured to receive a conversion configuration message from a co-ordinator function, the conversion configuration message including information to configure the training function to convert received transformed training data to and/or received combined transformed training data to converted training data.

The conversion configuration message may include information to configure the training function to convert received transformed training data to and/or received combined transformed training data to converted training data by augmentation, superimposing, averaging, filtering, pruning, puncturing, normalising, scaling and/or translation. The conversion may be by a suitable filtering or projection operation.

The training data may comprise an N-dimension matrix of values collected by a collector function.

The values may comprise channel information. The channel information may relate to a wireless link between an entity hosting the collector function and a transmitter. The channel information may comprise beamforming and/or channel values.

The transformed first training data may comprise an N-dimension matrix of values collected by the collector function.

The training function may be configured to combine received transformed training data to form combined transformed training data.

The training function may be configured to combine received transformed training data by superimposing, averaging, filtering, pruning, puncturing, scaling and/or normalising. The messages and/or data may be transmitted on a Physical Sidelink Shared Channel, a Physical Downlink Shared Channel, a Physical Uplink Shared Channel and/or any wireless medium channel. The messages and/or data may be transmitted on a Physical Sidelink Control Channel, Physical Downlink Common Control Channel and/or Physical Uplink Common Channel. The messages and/or data may be transmitted on other than an air-interface such as over F1, Xn and/or NG interfaces. The messages and/or data may be transmitted over O-RAN A1, E1, E2, F1 interfaces. It will be appreciated that these are applicable to 4G, 5G and 6G systems.

The training data, transformed training data and/or transformed training data may comprise a data format specified by a combination of parameters associated with the training data such as: sampling resolution; array shape: scalar, vector, matrix; and/or length, and the like.

According to various, but not necessarily all, example embodiments of the invention there is provided a method, comprising: receiving a conversion configuration message from a co-ordinator function, the conversion configuration message including information to configure a training function to convert received transformed training data to and/or received combined transformed training data to converted training data.

The conversion configuration message may include information to configure the training function to convert received transformed training data to and/or received combined transformed training data to converted training data by augmentation, superimposing, averaging, filtering, pruning, puncturing, normalising, scaling and/or translation. The conversion may be by a suitable filtering or projection operation.

The training data may comprise an n-dimension matrix of values collected by a collector function.

The values may comprise channel information. The channel information may relate to a wireless link between an entity hosting the collector function and a transmitter. The channel information may comprise beamforming and/or channel values.

The transformed first training data may comprise an N-dimension matrix of values collected by the collector function.

The method may comprise combining received transformed training data to form combined transformed training data.

The method may comprise combining received transformed training data by superimposing, averaging, filtering, pruning, puncturing, scaling and/or normalising.

The messages and/or data may be transmitted on a Physical Sidelink Shared Channel, a Physical Downlink Shared Channel, a Physical Uplink Shared Channel and/or any wireless medium channel. The messages and/or data may be transmitted on a Physical Sidelink Control Channel, Physical Downlink Common Control Channel and/or Physical Uplink Common Channel. The messages and/or data may be transmitted on other than an air-interface such as over F1, Xn and/or NG interfaces. The messages and/or data may be transmitted over O-RAN A1, E1, E2, F1 interfaces. It will be appreciated that these are applicable to 4G, 5G and 6G systems.

The training data, transformed training data and/or transformed training data may comprise a data format specified by a combination of parameters associated with the training data such as: sampling resolution; array shape: scalar, vector, matrix; and/or length, and the like.

According to various, but not necessarily all, example embodiments of the invention there is provided an apparatus, comprising: at least one processor; and
at least one memory storing instructions that when executed by the at least one processor cause the apparatus at least to perform the method and its example embodiments set out above.

According to various, but not necessarily all, example embodiments of the invention there is provided a non-transitory computer readable medium comprising program instructions stored thereon for performing the method and its example embodiments set out above.

Further particular and preferred aspects are set out in the accompanying independent and dependent claims. Features of the dependent claims may be combined with features of the independent claims as appropriate, and in combinations other than those explicitly set out in the claims.

Where an apparatus feature is described as being operable to provide a function, it will be appreciated that this includes an apparatus feature which provides that function or which is adapted or configured to provide that function.

### BRIEF DESCRIPTION

Some example embodiments will now be described with reference to the accompanying drawings in which:

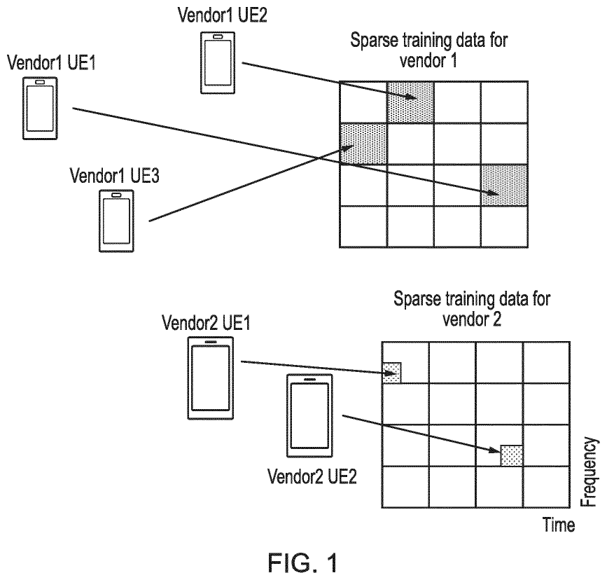

FIG. 1 illustrates training data scarcity;

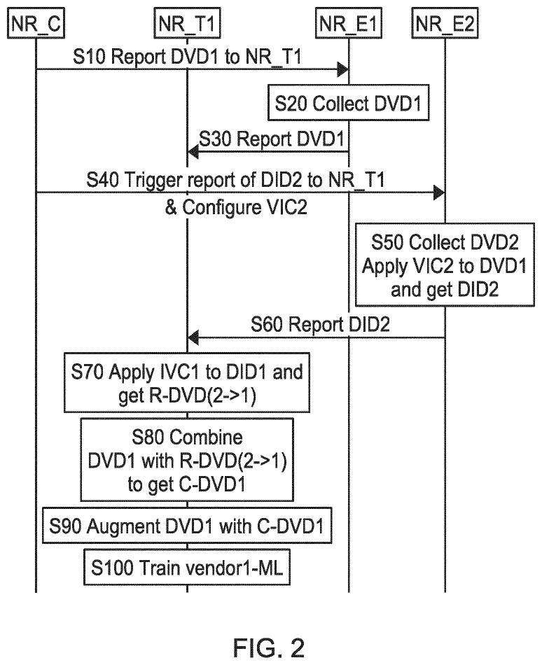

FIG. 2 is a signalling chart Signalling chart where data from vendor 2 is used to enhance data of vendor 1;

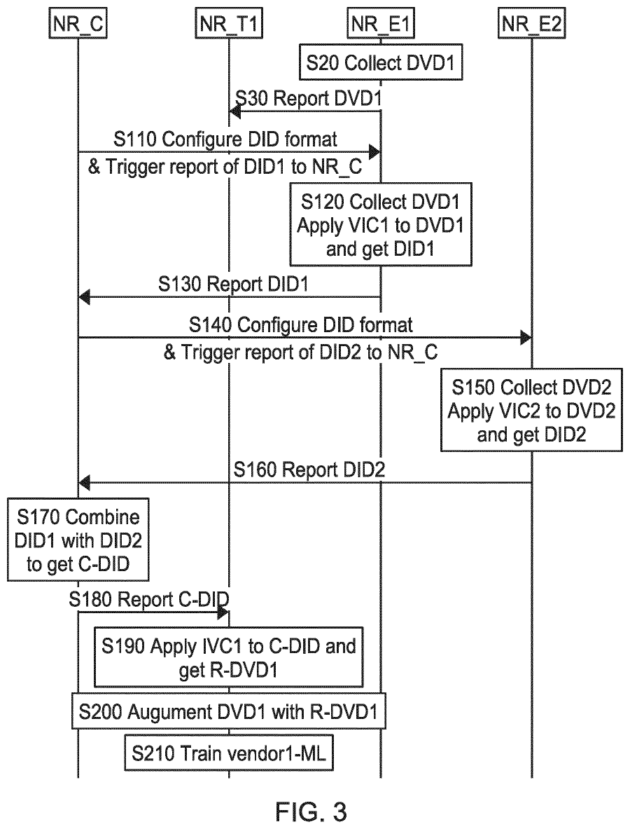

FIG. 3 is a signalling chart where data from vendor 2 is used to enhance data of vendor 1 and a controller function (NR-C) performs the combination of vendor-agnostic/domain invariant data (DID1 and DID2);

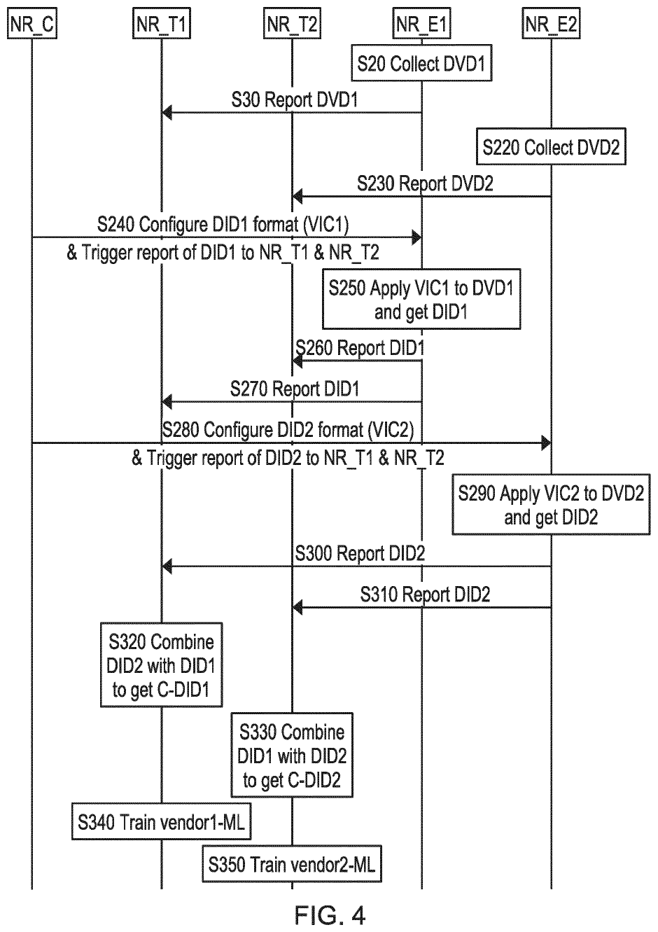

FIG. 4 is a signalling chart when multiple NR_E report DID to multiple NR_T—this approach can be combined with the approaches in FIGS. 2 and/or 3;

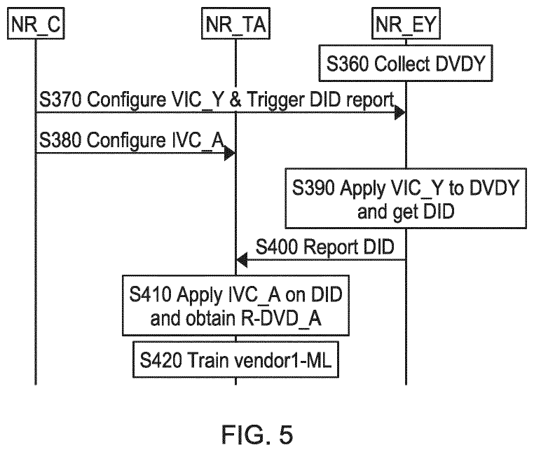

FIG. 5 is a signalling chart when multiple NR_E report DID to multiple NR_T—this approach can be combined with the approaches in FIGS. 2, 3 and/or 4;

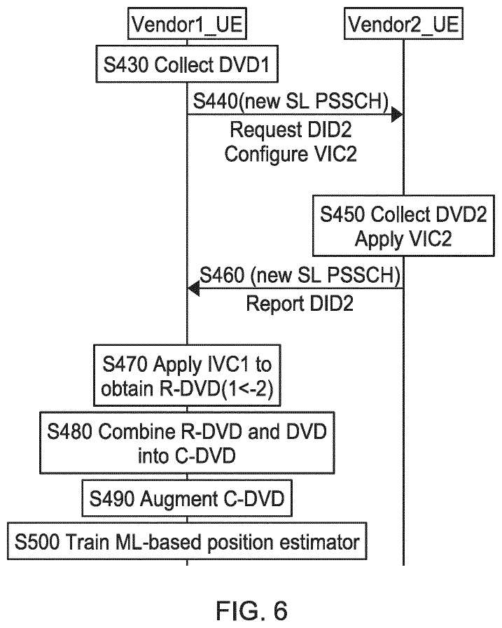

FIG. 6 is a signalling chart for a SL positioning example; and

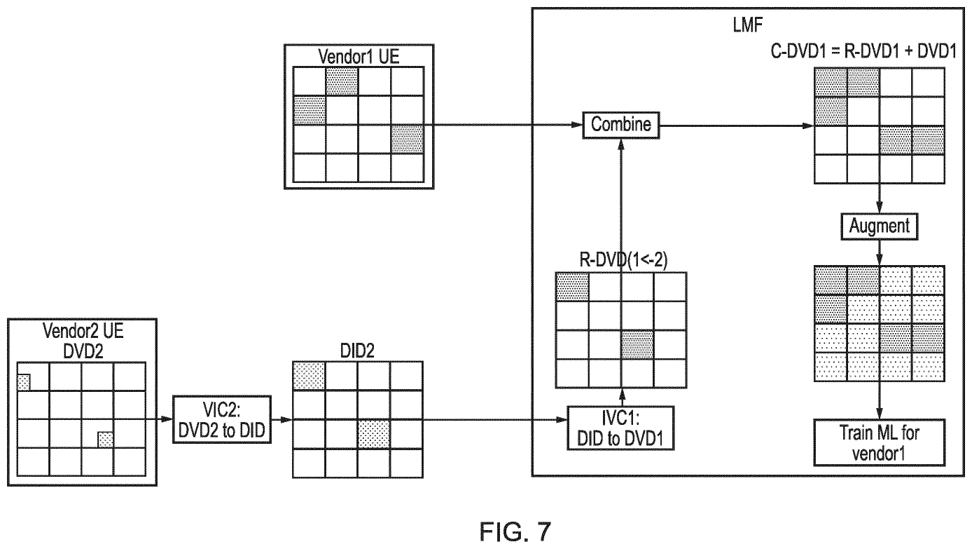

FIG. 7 illustrates an enhanced positioning use-case. An entry in a DVD (or DID) matrix, DVD(a, b) represents the UE-specific positioning measurement obtained at frequency resource a*Fs, and time resource b*Ts, where Fs and Ts are the sampling frequency and respectively sampling time specific to the UE.

### DETAILED DESCRIPTION

Before discussing the example embodiments in any more detail, first an overview will be provided. Some example embodiments provide a technique whereby network nodes within a wireless telecommunications network are provided with functions which co-ordinate, collect and use training data to train ML models to perform various network and/or device-specific tasks, generically referred to as radio resource management (RRM). Typically, collection functions within network nodes which are provided by the same vendor as the network node with the training function using the training data can receive their training data with values and in a format known to that training function. In some embodiments, even collection functions within network nodes which are provided by the same vendor as the network node with the training function using the training data provide their training data in an agnostic or invariant form. Collector functions within network nodes which are provided by a vendor which is different to the network node with the training function using the training data provide their training data in the agnostic or invariant form which does not disclose vendor-specific information about the capabilities of the entity that collected the data. This training data can be provided to either a co-ordinator function which combines the received data or to the training function for combining the received data. The training function is typically provided with information such as details of a transformation which can then transform or convert the combined data into a format which can then be used by the training function to train their (vendor-specific) ML model. This approach helps to collect a diverse range of training data in a consistent manner from network nodes provided by other vendors.

Some example embodiments relate to Rel-18 Study Item (SI) on Artificial Intelligence (AI)/Machine Learning (ML) for the New Radio (NR) Air Interface [3GPP RP-213599]. The SI aims at exploring the benefits of augmenting the air interface with features enabling support of AI/ML-based algorithms for enhanced performance and/or reduced complexity/overhead. This SI's target is to lay the foundation for future air-interface use cases leveraging AI/ML techniques. The initial set of use cases to be covered include Channel State Information (CSI) feedback enhancement (e.g., overhead reduction, improved accuracy, prediction, etc.), beam management (e.g., beam prediction in time, and/or spatial domain(s) for overhead and latency reduction, beam selection accuracy improvement, etc.), positioning accuracy enhancements, and the like. For those use cases, the benefits shall be evaluated (utilizing developed methodology and defined Key Performance Indicators (KPIs)) and the potential impact on the specifications shall be assessed including Physical (PHY) layer aspects, protocol aspects, etc. One of the key expected outcomes of the SI is “The AI/ML approaches for the selected sub use cases need to be diverse enough to support various requirements on the gNode B-User Equipment (gNB-UE) collaboration levels.” It must be noted that in the Work Item (WI) phase of “AI/ML for air interface”, additionally other use cases might also be addressed. Starting from Release 18, it is very likely a large variety of use cases and applications on ML in the gNB and UE will be proposed. Rel. 17 Positioning Reference Unit (PRU)—a PRU is a 5G network entity that may be designated by the 5G NR network to assist with one or more positioning sessions. A PRU is a device or network node with known location (e.g. a road-side unit, another UE, etc.) that can be activated on demand by the location management function (LMF) to perform specific positioning operations, e.g. measurement and/or transmission of specific positioning signals. The RAN1 Liaison Statement (LS) on PRU [R2-2106920]-RAN1 has evaluated the use of positioning reference units (PRUs) with known locations for positioning and observes improvements in using PRUs for enhancing the positioning performance. Notes: The term “positioning reference unit (PRU)” is only used as a terminology in this discussion. PRU does not necessarily mean an introduction of a new network node. PRU may support, at least, some of the Rel-16 positioning functionalities of UE, if agreed, which is up to RAN2. The positioning functionalities may include, but not limited to, the following: Provide the positioning measurements (e.g., Reference Signal Time Difference (RSTD), Reference Signal Received Power (RSRP), Reception-Transmission (Rx-Tx) time differences); Transmit the Uplink (UL) Sounding Reference Signals (SRS) for positioning-PRU may be requested by the LMF to provide its own known location coordinate information to the LMF. If the antenna orientation information of the PRU is known, the information may also be requested by the LMF. Rel. 18 ML models for Radio Resource Management (RRM) are expected to be vendor-specific and thus trained on vendor-specific data. A foreseeable RAN outcome is that companies agree that a vendor-specific ML model is trained for the same RRM functions, using vendor-specific training data only, so that training data is not exchanged among vendors. That are several reasons why vendors (UE and/or gNBs) do not want to share their data: It is UE-specific and in many cases sensitive; and it gives them a competitive edge by enabling them to generate and deploy their ML-based solutions that overperform competitors solutions.

As illustrated in FIG. 1, therefore, data collection for training vendor-specific ML models is expected to become a lengthy process, which most likely will result in a suboptimal training dataset that remains: unbalanced i.e., a large imbalance between minority and majority labels.; and sparse i.e., collected data does not characterize well all scenarios of interest.

To at least alleviate some of the above limitations and ensure that a robust, yet vendor-specific ML model is trained, vendor specific data would benefit from being artificially diversified and enlarged on a per-vendor basis, before used for training a vendor-based ML model. The process of artificially enhancing training data is referred to as data augmentation and the success of the procedure depends on two main factors: the amount and quality of the initial training data; and on the augmentation algorithm and it design assumptions. However, no concrete proposals exist at this stage on how the required training data is to be collected from the different UEs in the network in order to enable vendor agnostic ML-enabled solutions.

Some example embodiments provide a technique through which vendor-specific training data (called henceforth domain-variant data) is diversified by using other vendors'data, without exposing/sharing the domain-variant datasets among vendors. To that end, the domain-variant data is first agnosticised i.e., stripped out of the vendor-specific properties. Three types of NR elements are involved and combinations of the functions may be performed by one NR element:

ML Coordinator function (NR-C)—A NR network element that plays the role of: aggregating training data collected by different UEs and/or from multiple UE vendors; and defining the format of the vendor-agnostic or transformed training data format that each UE should transfer back to NR-C. NR-C may be a gNB-CU, NRT-RIC, NWDAF, etc.

ML Data Collector function (NR-E)—A NR network element that plays the role of collecting/modifying raw data as instructed by NR-C in a first or vendor-specific format and transferring the data to NR-T or NR-C using the vendor-agnostic or transformed format. NR-E may be a UE, gNB-CU, RT-RIC, RSU, etc. By NR-Ek we mean the NR-E which collects vendor-k's specific training data.

ML Training function (NR-T)—A NR network element that combines training data from different sources e.g., multiple NR-E and trains a vendor-specific ML function. NR-T may be NWDAF, LMF, serving gNB, or a UE. NR-T may be in the same network element as the corresponding NR-E, e.g. gNB or UE. By NR-Tm we mean the NR-T which trains the ML model for vendor m.

### Provide Training Data From Vendor 2 to Vendor 1

An example embodiment is shown in FIG. 2 where the coordinator function configures data collector functions to provide training data to the training function. One of the data collector functions is from the same vendor as the training function and so is able to provide its training data in a form expected by that training function. The other data collector function is from a different vendor and so is instructed to collect specified training data, transform that training data into a specified format and provide that transformed training data to the training function. The training function then converts the transformed training data to match the form of the training data provided by the data collectors function from the same vendor as the training function, combines the training data and uses that combined training data to train the ML model.

The Nr-C configures each vendor k's element NR-Ek, k=1 . . . K to provide their training data in a given format.

Accordingly, step S10, the NR_C instructs NR_E1 to provide training data to NR_T1 in a vendor-specific format, called domain variant data (DVD), when the training data and ML training are for the same vendor. At step S20, NR_E1 collects the training data DVD1 in the vendor-specific format and at step S30 reports that training data DVD1 to NT_T1.

At step S40, the NR_C instructs NR_E2 to provide training data to NR_T2 in a vendor-agnostic format, called domain invariant data (DID) format, if the vendor for which the training is required is different from the vendor for which the data is collected. NR_C defines how DID is obtained at each NR-Ek side by providing details of a Vendor-to-Invariant Conversion (VIC) or transformation, as described in more detail below.

At step S50, each NR-Ek, k=1 . . . , K, transforms domain-variant data k (DVD(k)) into DID using the VIC provided by the NR_C. DID has a unique format (format, size, type e.g. integer, real values, etc.) and may be scenario specific e.g.: DID for beamforming may be a 2D or 3D matrix of real values, where each entry is the RSRP of an RS at a given (time, frequency) or (time, frequency, space) position; DID for positioning enhancements may be a 3D matrix of complex values where each entry is the channel gain at a given (time, delay, space) position; Generating a universally understood/agreed DID format that can be used among different UE vendors/domains. The DVD to DID conversion (VIC) is configured by NR-C and typically has the following goals: stripping DVD from sensitive information (UE specific data payloads, symbols, identifiers); stripping DVD from vendor-specific artifacts e.g. UE specific TX/RX delay, beam offsets, etc. Note that the exact form of the VIC transformation to be applied to DVD to get DID is derived in the NR_E which performs the transformation. The VIC parameterization may be configured fully/totally by NR-C and may constrain: DID format; DID reporting periodicity; a target VIC performance, where the performance metric is use-case dependent.

At step S60 the NR-Ek sends their DIDk to NR-Tm. Alternatively, the DID may be first sent to NR-C, which forwards it to each NR-Tm.

At step S70, using the DID from domains k, k=1:K, NR-Tm diversifies DVDm, where m≠k: Each DID(k), k=1 . . . K is used to reconstruct DID(k) to DVD(m). The reconstruction or conversion process consists of inputting DID(k) to a module that applies a domain-m-specific transformation to DID and outputs an approximate DVD(m), called reconstructed DVD: R-DVD(→m). The conversion from DID to R-DVD (invariant-to-variant conversion (IVC)) is the opposite of VIC and comprises translating DID to a DVD format and also including the domain-specific information where available (use case dependent). This conversion ensures the R-DVD has the same properties and formatting as the DVDm of the particular UE vendor m. The exact form of the IVC transformation needs to be known only at the vendor-specific functions (NR_T and/or NR_E).

At step S80, NR-Tm uses all R-DVD(k→m), k=1 . . . K to combine with the original DVD(m) into a superset C-DVD(m)=Combine{R-DVD(kΔm), ∀k=1 . . . K, DVD(m)}. The function Combine may consist of various operations such as superimposing the datasets, averaging, filtering, etc.

At step S90, C-DVD(m) is augmented to obtain the final training dataset for domain m, and, at step S100, to train a domain-m-specific ML model. Such augmentation typically comprises concatenation of data sets, random mix of data sets, and the like.

In other words, Vendor1 requires training of an ML module. NR_T1 is the function that trains the vendor1-specific ML model. NR_T1 is configured by NR_C to collect: DVD1 from NR_E1, where NR_E1 is of vendor1—here, data may be shared directly, since both training and data are of the same vendor; DID2 from NR_E2, where NR_E2 is of vendor2 and thus data needs to be agnosticized to the vendor prior to sharing. NR_E1 and NR_E2 are configured by NR_C to collect training data and share it with NR_T1. NR_E2 is configured by NR_C to apply a specific VIC2 to translate its own DVD2 to DID2. NR_T1 is configured by NR_C to apply an IVC1 to DID2, so that DID2 is transformed into R-DVD(2→1), reconstructed-DVD, i.e. data that vendor1 can use for training, and originated from vendor2 NR element. NR_T1 then combines DVD1 and R-DVD(2→1), where such combination function is generically denoted Combine1. The function Combine1 may performing any of the operations: Superimposition of DVD1 and R-DVD(2→1); Averaging; Filtering; Pruning; Puncturing; Scaling; Normalisation; A combination of the above operations.

An example embodiment is shown in FIG. 3 where the coordinator function configures data collector functions to provide training data to the coordinator function. One of the data collector functions is from the same vendor as the training function and so is able to provide its training data in a form expected by that training function but is instructed to collect specified training data, transform that training data into a specified format and provide that transformed training data to the coordinator function. The other data collector function is from a different vendor and is instructed to collect specified training data, transform that training data into a specified format and provide that transformed training data to the coordinator function. The coordinator function then combines the training data and provides this to the training function. The training function converts the transformed training data to match the form of the training data provided by the data collectors function from the same vendor as the training function and uses that training data to train the ML model.

In particular, the NR-C function collects DID(k) and combines them into a combined DID (C-DID) which is then sent to the NR-T of specific vendor. The NR_C configures the target DID format for all NR_E from which the data is to be collected. Each NR_E is assumed to be able to derive the corresponding VIC transformation knowing the DID format and its own DVD format. NR_T knows the inverse transformation IVC corresponding to vendor for which the training data is to be generated.

Accordingly, the NR_C instructs NR_E1 to provide training data to NR_T1 in a vendor-specific format, called domain variant data (DVD), when the training data and ML training are for the same vendor. At step S20, NR_E1 collects the training data DVD1 in the vendor-specific format and at step S30 reports that training data DVD1 to NT_T1.

At steps S110 & S140, the NR_C instructs NR_E1 and NR_E2 to provide training data to NR_C in a vendor-agnostic format, called domain invariant data (DID) format. NR_C defines how DID is obtained at each NR-Ek side by providing details of a Vendor-to-Invariant Conversion (VIC) or transformation, as described in more detail below.

At steps S120 & S150, each NR-Ek, k=1 . . . K, transforms domain-variant data k (DVD(k)) into DID using the VIC provided by the NR_C. DID has a unique format (format, size, type e.g. integer, real values, etc.) and may be scenario specific e.g.: DID for beamforming may be a 2D or 3D matrix of real values, where each entry is the RSRP of an RS at a given (time, frequency) or (time, frequency, space) position; DID for positioning enhancements may be a 3D matrix of complex values where each entry is the channel gain at a given (time, delay, space) position; Generating a universally understood/agreed DID format that can be used among different UE vendors/domains. The DVD to DID conversion (VIC) is configured by NR-C and typically has the following goals: stripping DVD from sensitive information (UE specific data payloads, symbols, identifiers); stripping DVD from vendor-specific artifacts e.g. UE specific TX/RX delay, beam offsets, etc. Note that the exact form of the VIC transformation to be applied to DVD to get DID is derived in the NR_E which performs the transformation. The VIC parameterization may be configured fully/totally by NR-C and may constrain: DID format; DID reporting periodicity; a target VIC performance, where the performance metric is use-case dependent.

At steps S130 & S160, each NR-Ek sends their DIDk to NR-C.

At step S170, NR-C combines all DIDk into a superset C-DID(m)=Combine{DID(k)}. The function Combine may consist of various operations such as superimposing the datasets, averaging, filtering, etc.

At step S180, C-DID is reported to NR_T1.

At step S190, using the C-DID, NR-T1 diversifies C-DID, to reconstruct C-DID to R-DVD1. The reconstruction or conversion process consists of inputting C-DID to a module that applies a domain-specific transformation to DID and outputs an approximate DVD, called reconstructed DVD: R-DVD. The conversion from DID to R-DVD (invariant-to-variant conversion (IVC)) is the opposite of VIC and comprises translating DID to a DVD format and also including the domain-specific information where available (use case dependent). This conversion ensures the R-DVD has the same properties and formatting as the DVDm of the particular UE vendor m. The exact form of the IVC transformation needs to be known only at the vendor-specific functions (NR_T and/or NR_E).

At step S200, R-DVD(m) is augmented to obtain the final training dataset for domain m, and, at step S210, to train a domain-m-specific ML model.

### Provide Training Data From Vendor 2 to Vendor 1 and From Vendor 1 to Vendor 2

An example embodiment is shown in FIG. 4 where the coordinator function configures data collector functions to provide training data to the training functions of a plurality of vendors. This example embodiment can be combined with the example embodiments set out above. The data collector functions are instructed to collect specified training data, transform that training data into a specified format and provide that transformed training data to the training functions. The training functions then combines the training data to match the form of the training data of that vendor and uses that training data to train their ML model.

Accordingly, the NR_C instructs NR_E1 & NR_E2 to provide training data to NR_T1 and NR_T2 in a vendor-specific format, called domain variant data (DVD). At step S20, NR_E1 collects the training data DVD1 in the vendor-specific format and at step S30 reports that training data DVD1 to NT_T1. At step S220, NR_E2 collects the training data DVD2 in the vendor-specific format and at step S230 reports that training data DVD1 to NT_T2.

At steps S240 & S280, the NR_C instructs NR_E1 and NR_E2 to provide training data to NR_T1 and NR_T2 in a vendor-agnostic format, called domain invariant data (DID) format. NR_C defines how DID is obtained at each NR-Ek side by providing details of a Vendor-to-Invariant Conversion (VIC) or transformation, as described in more detail below.

At steps S250 & S290, each NR-Ek, k=1 . . . K, transforms domain-variant data k (DVD(k)) into DID using the VIC provided by the NR_C. DID has a unique format (format, size, type e.g. integer, real values, etc.) and may be scenario specific e.g.: DID for beamforming may be a 2D or 3D matrix of real values, where each entry is the RSRP of an RS at a given (time, frequency) or (time, frequency, space) position; DID for positioning enhancements may be a 3D matrix of complex values where each entry is the channel gain at a given (time, delay, space) position; Generating a universally understood/agreed DID format that can be used among different UE vendors/domains. The DVD to DID conversion (VIC) is configured by NR-C and typically has the following goals: stripping DVD from sensitive information (UE specific data payloads, symbols, identifiers); stripping DVD from vendor-specific artifacts e.g. UE specific TX/RX delay, beam offsets, etc. Note that the exact form of the VIC transformation to be applied to DVD to get DID is derived in the NR_E which performs the transformation. The VIC parameterization may be configured fully/totally by NR-C and may constrain: DID format; DID reporting periodicity; a target VIC performance, where the performance metric is use-case dependent.

At steps S260, S270, S300 & S310, each NR-Ek sends their DIDk to both NR_T1 and NR_T2.

At steps S320 and S330, NR-T1 & NR_T2 combines all DIDk into a superset C-DID(m)=Combine{DID(k)}. The function Combine may consist of various operations such as superimposing the datasets, averaging, filtering, etc.

At steps S340 and S350, C-DID(m) is used to train a domain-m-specific ML model.

Optionally instead, using the C-DID, NR-T1 and NR_T2 diversifies C-DID, to reconstruct C-DID to R-DVD1 and R-DVD1. The reconstruction or conversion process consists of inputting C-DID to a module that applies a domain-specific transformation to DID and outputs an approximate DVD, called reconstructed DVD: R-DVD. The conversion from DID to R-DVD (invariant-to-variant conversion (IVC)) is the opposite of VIC and comprises translating DID to a DVD format and also including the domain-specific information where available (use case dependent). This conversion ensures the R-DVD has the same properties and formatting as the DVDm of the particular UE vendor m. The exact form of the IVC transformation needs to be known only at the vendor-specific functions (NR_T and/or NR_E). R-DVD(m) is augmented to obtain the final training dataset for domain m, and to train a domain-m-specific ML model.

### Provide Training Data From Vendor Y to Vendor A

An example embodiment is shown in FIG. 5 where the coordinator function from one vendor configures data collector function(s) from other vendor(s) to provide training data to the training functions of other vendor(s). This example embodiment can be combined with the example embodiments set out above. The data collector function(s) are instructed to collect specified training data, transform that training data into a specified format and provide that transformed training data to the training function(s). The training function(s) then combines the training data to match the form of the training data of that vendor and uses that training data to train their ML model.

At step S20, NR_EY collects the training data DVDY in the vendor-specific format.

At step S370, the NR_C instructs NR_EY to provide training data to NR_TA in a vendor-agnostic format, called domain invariant data (DID) format. NR_C defines how DID is obtained at each NR-Ek side by providing details of a Vendor-to-Invariant Conversion (VIC) or transformation, as mentioned above.

At step S380, the NR_C reports the conversion from DID to R-DVD (invariant-to-variant conversion (IVC)) which includes domain-specific information where available (use case dependent). This conversion ensures the R-DVD has the same properties and formatting as the DVDm of the particular UE vendor m. In this example, IVC_A provides the conversion from DID to R-DVD_A.

At step S390, each NR-Ek, k=1 . . . K, transforms domain-variant data k (DVD(k)) into DID using the VIC provided by the NR_C. DID has a unique format (format, size, type e.g. integer, real values, etc.) and may be scenario specific e.g.: DID for beamforming may be a 2D or 3D matrix of real values, where each entry is the RSRP of an RS at a given (time, frequency) or (time, frequency, space) position; DID for positioning enhancements may be a 3D matrix of complex values where each entry is the channel gain at a given (time, delay, space) position; Generating a universally understood/agreed DID format that can be used among different UE vendors/domains. The DVD to DID conversion (VIC) is configured by NR-C and typically has the following goals: stripping DVD from sensitive information (UE specific data payloads, symbols, identifiers); stripping DVD from vendor-specific artifacts e.g. UE specific TX/RX delay, beam offsets, etc. Note that the exact form of the VIC transformation to be applied to DVD to get DID is derived in the NR_E which performs the transformation. The VIC parameterization may be configured fully/totally by NR-C and may constrain: DID format; DID reporting periodicity; a target VIC performance, where the performance metric is use-case dependent.

At steps S400, each NR-Ek sends their DIDk to NR_TA.

At step S410, using the DID, NR-TA diversifies DID, to reconstruct DID to R-DVD_A. The reconstruction or conversion process consists of inputting DID to a module that applies a domain-specific transformation to DID and outputs an approximate DVD, called reconstructed DVD: R-DVD. This conversion ensures the R-DVD has the same properties and formatting as the DVDm of the particular UE vendor m. R-DVD_A is augmented to obtain the final training dataset for domain m, and, at step S400, to train a domain-m-specific ML model.

### Sidelink (SL) Positioning

As illustrated in FIG. 6, in an example embodiment, for SL positioning, a vendor1 UE trains an ML-based position estimator using its own data DVD1 and DID2 collected from vendor2 UEs. Although this example relates to positioning, it will be appreciated that this technique is applicable to other use cases.

At step S430, vendor1 UE collects collect time-frequency measurements of the DL PRS and stores them in the matrix DVD1.

At step S440, Vendor2 UEs are instructed by the vendor1 UE to collect time-frequency measurements of the DL PRS and stores them in the matrix DVD2, where:
DVD2(i, j)=channel frequency response at frequency i*Fs2, and time j*Ts2, were Fs2 and Ts2 are sampling frequency and time, both specific to the vendor2 UEs, and i≠a, j≠b.

Using a new SL PSSCH IE, Vendor1 UE configures vendor2 UEs to report DID2, where DID2 is produced by the convertor VIC2 for all vendor2UEs.

Vendor1 UE configures VIC2 parameters. For example, VIC2 should output DID2, where:
DID2(i, j)=CFR at i*Fs1, and time i*Ts1, in other words, the DVD2 should be resampled at a rate Fs1 and its resolution changed from Ts2 to Ts1.
The RX beam response of vendor2 UE, i.e. W2 is removed from DVD2. For example, VIC2 should apply a transformation of DVD2 as: DID2=inv(W2)*DVD2.

At step S450, Vendor2 UEs collect DVD2, apply VIC2 as instructed and, at step S460, report DID2 to LMF.

At step S470, Vendor1 UE uses DID2 and the convertor IVC2 to reconstruct R-DVD(2→1). In other words, it applies its own responses to DID2, to artificially generate how vendor1 UE data would look like at resource index (i, j).

Next, at step 480, it combines DVD1 with R-DVD(2→1) into C-DVD(1). For example, it may superimpose the two matrices, or compute an average response of the two.

At step S490, it uses C-DVD1 and a preferred state-of-art augmentation method (scaling, translation, etc.) to produce an augmented DVD1.

At step S500, the augmented set is then used to train a preferred state-of-art ML-based position estimator (e.g. Deep Neural Network (DNN) with rectified linear unit (ReLU) activation function).

### UE-Assisted DL Positioning

As illustrated in FIG. 7, in an example embodiment, involves UE-assisted DL positioning, where the NR_T (or an associated Network Data Analytics Function (NWDAF) function) trains a ML-based position estimator for UE vendor1, using DVD of vendor1 UEs and DID2 collected from vendor2 generally using the technique described in FIG. 3.

Vendor1 UEs are instructed by the NR-C to collect time-frequency measurements of the DL PRS and stores them in the matrix DVD1, where:
DVD1(a, b)=channel frequency response at frequency a*Fs1, and time b*Ts1, were Fs1 and Ts1 are sampling frequency and time, both specific to the vendor1 UEs.

A new LPP IE is used for Vendor1 UEs report DVD to the NR_T.

Vendor2 UEs are instructed by the NR_C to collect time-frequency measurements of the DL PRS and store them in the matrix DVD2, where:
DVD2(i, j)=channel frequency response at frequency i*Fs2, and time j*Ts2, were Fs2 and Ts2 are sampling frequency and time, both specific to the vendor2 UEs, and i≠a, j≠b.

A new LPP IE is used so the NR_C configures vendor2 UEs to report DID2, where DID2 is produced by the convertor VIC2 for all vendor2UEs.

NR_C configures VIC2 parameters. For example, VIC2 should output DID2, where:
DID2(i, j)=CFR at i*Fs1, and time i*Ts1, in other words, the DVD2 should be resampled at a rate Fs1 and its resolution changed from Ts2 to Ts1.
The RX beam response of vendor2 UE, i.e. W2 is removed from DVD2. For example, VIC2 should apply a transformation of DVD2 as: DID2=inv(W2)*DVD2.

Vendor2 UEs collect DVD2, apply VIC2 as instructed and report DID2 to NR_C.

NR_T uses DID2 and the convertor IVC2 to reconstruct R-DVD(2→1). In other words, the NR_T applies vendor1 UE specific responses to DID2, to artificially generate how vendor1 UE data would look like at resource index (i, j).

NR_T combines DVD1 with R-DVD(2→1) into C-DVD(1). For example, NR_T may superimpose the two matrices, or compute an average response of the two.

NR_T uses C-DVD1 and a preferred state-of-art augmentation method (scaling, translation, etc.) to produce an augmented DVD1.

The augmented set is then used to train a preferred state-of-art ML-based position estimator (e.g. DNN with ReLU activation function).

A person of skill in the art would readily recognize that steps of various above-described methods can be performed by programmed computers. Herein, some embodiments are also intended to cover program storage devices, e.g., digital data storage media, which are machine or computer readable and encode machine-executable or computer-executable programs of instructions, wherein said instructions perform some or all of the steps of said above-described methods. The program storage devices may be, e.g., digital memories, magnetic storage media such as a magnetic disks and magnetic tapes, hard drives, or optically readable digital data storage media. The embodiments are also intended to cover computers programmed to perform said steps of the above-described methods. The tern non-transitory as used herein, is a limitation of the medium itself (i.e., tangible, not a signal) as opposed to a limitation on data storage persistency (e.g. RAM vs ROM).

As used in this application, the term “circuitry” may refer to one or more or all of the following:
(a) hardware-only circuit implementations (such as implementations in only analog and/or digital circuitry) and
(b) combinations of hardware circuits and software, such as (as applicable):
   (i) a combination of analog and/or digital hardware circuit(s) with software/firmware and
   (ii) any portions of hardware processor(s) with software (including digital signal processor(s)), software, and memory(ies) that work together to cause an apparatus, such as a mobile phone or server, to perform various functions) and
(c) hardware circuit(s) and or processor(s), such as a microprocessor(s) or a portion of a microprocessor(s), that requires software (e.g., firmware) for operation, but the software may not be present when it is not needed for operation.

This definition of circuitry applies to all uses of this term in this application, including in any claims. As a further example, as used in this application, the term circuitry also covers an implementation of merely a hardware circuit or processor (or multiple processors) or portion of a hardware circuit or processor and its (or their) accompanying software and/or firmware. The term circuitry also covers, for example and if applicable to the particular claim element, a baseband integrated circuit or processor integrated circuit for a mobile device or a similar integrated circuit in server, a cellular network device, or other computing or network device.

Although example embodiments of the present invention have been described in the preceding paragraphs with reference to various examples, it should be appreciated that modifications to the examples given can be made without departing from the scope of the invention as claimed.

Features described in the preceding description may be used in combinations other than the combinations explicitly described.

Although functions have been described with reference to certain features, those functions may be performable by other features whether described or not.

Although features have been described with reference to certain embodiments, those features may also be present in other embodiments whether described or not.

Whilst endeavouring in the foregoing specification to draw attention to those features of the invention believed to be of particular importance it should be understood that the Applicant claims protection in respect of any patentable feature or combination of features hereinbefore referred to and/or shown in the drawings whether or not particular emphasis has been placed thereon.

1. An apparatus, comprising:
at least one processor; and
at least one memory storing instructions that, when executed by the at least one processor, cause the apparatus to:
send a first configuration message to a first collector function, said first configuration message including information to configure said first collector function to collect first training data, to transform said first training data into a first format to generate transformed first training data and to report said transformed first training data.

2. The apparatus of claim 1, wherein said first configuration message includes information to configure said first collector function to:
transform said first training data to generate said transformed first training data by removing specified vendor-specific data or artifacts; or
report said transformed first training data in a reporting format or with a specified reporting periodicity.

3. The apparatus of claim 1, wherein said first configuration message includes information to configure said first collector function to:
report said transformed first training data to said apparatus or to a training function; or
report said transformed first training data to both a first training function and a second training function.

4. The apparatus of claim 1, wherein said apparatus is configured to send a second configuration message to a second collector function, said second configuration message including information to configure said second collector function to collect second training data, to reconfigure said second training data to generate transformed second training data and to report said transformed second training data.

5. The apparatus of claim 1, wherein said apparatus is configured to combine received transformed training data to form combined transformed training data and to send said combined transformed training data to said training function.

6. The apparatus of claim 1, wherein said apparatus is configured to send a configuration message to a collector function provided by a vendor common to said apparatus and said collector function, said configuration message including instructions to configure said collector function to collect training data and to report said training data.

7. The apparatus of claim 1, wherein said apparatus is configured to send a conversion configuration message to said training function, said conversion configuration message including information to configure said training function to convert received transformed training data to or received combined transformed training data to converted training data.

8. The apparatus of claim 7, wherein said conversion configuration message includes information to configure said training function to convert received transformed training data to or received combined transformed training data to converted training data by augmentation, averaging, filtering, pruning, puncturing, normalising, scaling or translation.

9. The apparatus of claim 1, wherein said apparatus is configured to send a first conversion configuration message to said first training function, said first conversion configuration message including information to configure said first training function to convert received transformed training data or received combined transformed training data to first converted training data and a second conversion configuration message to a second training function, said second conversion configuration message including information to configure said second training function to convert received transformed training data or received combined transformed training data to second converted training data.

10. The apparatus of claim 1, wherein said messages or data are transmitted on a Physical Sidelink Shared Channel, a Physical Downlink Shared Channel, or a Physical Uplink Shared Channel.

11. (canceled)

12. An apparatus, comprising:
at least one processor; and
at least one memory storing instructions that, when executed by the at least one processor, cause the apparatus to:
receive a configuration message from a co-ordinator function, said configuration message including information to configure said apparatus to collect training data, to transform said training data into a first format to generate transformed training data and to report said transformed training data; and
collect the training data, transform the training data, and report the transformed training data according to the configuration message.

13. (canceled)

14. An apparatus, comprising:
at least one processor; and
at least one memory storing instructions that, when executed by the at least one processor, cause the apparatus to:
receive a conversion configuration message from a co-ordinator function, said conversion configuration message including information to configure said apparatus to convert received transformed training data or received combined transformed training data to converted training data in a predetermined format; and
convert the received transformed training data or the received combined transformed training data into the converted training data in the predetermined format.

15. (canceled)

16. The apparatus of claim 12, wherein the configuration message includes information to configure the apparatus to:
transform the training data to generate said transformed training data by removing specified vendor-specific data or artifacts; or
report said transformed training data in a reporting format or with a specified reporting periodicity.

17. The apparatus of claim 12, wherein the configuration message includes information to configure the apparatus to:
report said transformed training data to the co-ordinator function or to a training function; or
report said transformed training data to both a first training function and a second training function.

18. The apparatus of claim 12, wherein said co-ordinator function is associated with a vendor common to said apparatus.

19. The apparatus of claim 12, wherein the configuration message is transmitted on a Physical Sidelink Shared Channel, a Physical Downlink Shared Channel, or a Physical Uplink Shared Channel.

20. The apparatus of claim 14, wherein said apparatus is configured to receive the combined transformed training data from the co-ordinator function.

21. The apparatus of claim 14, wherein said conversion configuration message includes information to configure said apparatus to convert the received transformed training data or the received combined transformed training data to converted training data by augmentation, averaging, filtering, pruning, puncturing, normalising, scaling, or translation.

22. The apparatus of claim 14, wherein the conversion configuration message is transmitted on a Physical Sidelink Shared Channel, a Physical Downlink Shared Channel, or a Physical Uplink Shared Channel.
